(19) United States
(12) Patent Application Publication
(10) Pub. No.: US 2025/0091824 A1
(43) Pub. Date: Mar. 20, 2025

(54) ROBOT-CONTROLLED LOADER SYSTEM

(71) Applicant: Dexterity, Inc., Redwood City, CA (US)

(72) Inventors: Cyril Nader, Redwood City, CA (US); Shawn Wang, Mountain View, CA (US); Abhay Prithvi Komanduri, Santa Clara, CA (US); Shalini Ragothaman, East Palo Alto, CA (US); Monika Spytek, Sunnyvale, CA (US); Robert Holmberg, Mountain View, CA (US); Timothy Ryan, San Francisco, CA (US); Tom Vardon, Niagara Falls (CA); Aaron Schultz, Palo Alto, CA (US); Stephan Pleines, San Mateo, CA (US)

(21) Appl. No.: 18/891,250

(22) Filed: Sep. 20, 2024

Related U.S. Application Data
(60) Provisional application No. 63/539,572, filed on Sep. 20, 2023.

(51) Int. Cl. B65G 67/08; B65G 43/02; B65G 65/02; B65G 67/20

(52) U.S. Cl. CPC B65G 67/08; B65G 43/02; B65G 65/02; B65G 67/20; B65G 2203/044

(57) ABSTRACT

A robotic loading/unloading system is disclosed. In various embodiments, sensor data is received via a communication interface. The sensor data is used to determine a position and orientation of an extendable conveyor relative to a robotic loader comprising one or more robotic arms mounted on a robotically controlled rover. The determined position and orientation of the extendable conveyor relative to the robotic loader are used to control one or both of the extendable conveyor and the robotic loader to place the extendable conveyor and robotic loader to position a distal end of the extendable conveyor within reach of the one or more robotic arms at a location within a work area from which one or more pick or placement locations within the work area are within reach of at least one of the one or more robotic arms.

### CROSS REFERENCE TO OTHER APPLICATIONS

This application claims priority to U.S. Provisional Patent Application No. 63/539,572 entitled ROBOT-CONTROLLED EXTENDABLE ADAPTER filed Sep. 20, 2023, which is incorporated herein by reference for all purposes.

### BACKGROUND OF THE INVENTION

Mobile robots have been provided to perform tasks such as loading or unloading a truck or shipping container; stacking items on or removing items from a pallet, etc. In some contexts, such as to load or unload a truck or container, the robot may drive into the truck or container. A telescopically extending conveyor system, such as may be found at a loading dock, may be used to carry items to the vicinity of the robot, for loading, or to receive items from the robot, in the case of unloading.

To avoid dropping packages and/or damaging equipment, operation of the telescopically extending conveyor and the loading/unloading robot must be coordinated. As the robot unloads, for example, it must advance further into the truck to retrieve the next layer of packages, and the extending conveyor must be advanced behind and/or with it so that the conveyor remains within reach of the robot. Conversely, as it loads, the robot backs out of the truck to create space to place the next wall/layer of packages, and the extending conveyor must be backed out of the truck or container with it.

### BRIEF DESCRIPTION OF THE DRAWINGS

Various embodiments of the invention are disclosed in the following detailed description and the accompanying drawings.

FIG. 1 is a diagram illustrating an embodiment of a robotic truck loader system.

FIG. 2A is a diagram illustrating an embodiment of a robotic truck loader system.

FIG. 2B is a diagram illustrating an embodiment of a robotic truck loader system.

FIG. 3A is a diagram illustrating an embodiment of a robotic truck loader system.

FIG. 3B is a diagram illustrating an embodiment of a robotic truck loader system.

FIG. 4A is a diagram illustrating an embodiment of a robotic truck loader system.

FIG. 4B is a diagram illustrating an embodiment of a robotic truck loader system.

FIG. 5 is a state diagram illustrating an embodiment of a process to control a robotic truck loader system.

FIG. 6 is a block diagram illustrating an embodiment of a control computer to control a robotic truck loader system.

FIG. 7 is a diagram illustrating an electrical connector used to provide a control interface between a robotic truck loader system and an extendable conveyor.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Structures and techniques are disclosed to allow for continuous and automated transfer of material between a robotic truck loading system and a package conveyor that carries packages to be handled by the robotic truck loading system. In various embodiments, techniques disclosed herein allow for the automated loading and unloading of a trailer with no human intervention. For loading, the extendable conveyor transfers packages to a position on the conveyor from which the robots pick the packages or, in some embodiments, to a transfer conveyor adjacent to and/or integrated with the robotic truck loader.

In various embodiments, a robotic truck loading system as disclosed herein comprises a robotic rover that transports and positions one or more robots (e.g., robotic arms). In the loading operation, in various embodiments, the robotic rover that transports the robots moves with the extendable conveyor to the end of the trailer. The package flow starts after the rover/extendable conveyor pair reach the end of the trailer and the robots start packing the truck. Once the robots have sufficiently packed the region in front of them the rover backs up continuously with the extendable conveyor maintaining relative positions and orientation between them to avoid packages being dropped or equipment damaged while maintaining a package pick area, e.g., on the extending conveyor or a transfer conveyor to which the extending conveyor delivers them, within reach of one or more robotic arms mounted on the rover. The operation continues until the whole trailer is packed.

During the unloading operation, the rover/extendable conveyor pair is positioned at the front of the trailer (i.e., the rear door but the “front” face of the load in the trailer) to begin. The robots will unload the trailer up to a distance that corresponds to the robots' reach. Once the robots cannot optimally unload the trailer the rover/extendable conveyor pair move in together to continue the operation until the trailer is empty. The rover/extendable conveyor pair maintain a relative position and orientation to avoid collision or package drop. When the trailer has been fully unloaded the extendable conveyor/rover pair make their way out of the trailer.

In various embodiments, the robotic system uses sensor data to determine and/or track one or more of the position, orientation, velocity, and other higher order derivatives of position of the extendable conveyor.

In various embodiments, one or more of the following are provided, present, and/or accommodated:
The rover and extendable conveyor maintain a relative position and orientation between them to both avoid collisions between the two systems and package fall from too large of a distance.
The rover/extendable conveyor pair move in a continuous, synchronized fashion, in some embodiments, or in a continuous fashion when circumstances allow but with stop and start movement as needed.
The extendable conveyor dynamics may not be able to be controlled and may vary from system to system.
The extendable conveyor does not have feedback to the robot.
The system is robust to external elements that might cause the extendable conveyor to stop its motion.
The safety systems of the 2 systems are linked such that motion in both systems is stopped in case of a safety event: ESTOP/PSTOP.
Synchronized, autonomous control is provided without adding more components, e.g., due to cost constraints.
The system adapts to the trailer being misaligned laterally with the extendable conveyor due to an angular or translational offset from the nominal (e.g., trailer parked at an angle to dock and/or at a lateral offset from the extendable conveyor).
The system adapts to the trailer having a vertical misalignment (e.g., with the loading dock) that is large enough to cause interference with the transfer conveyor.
The extending conveyor (or transfer conveyor, where present) may have tight misalignment tolerances, e.g., it may have side guards to avoid packages dropping on its sides. The system tracks the extendable conveyor laterally and angularly to ensure adequate spacing and alignment.

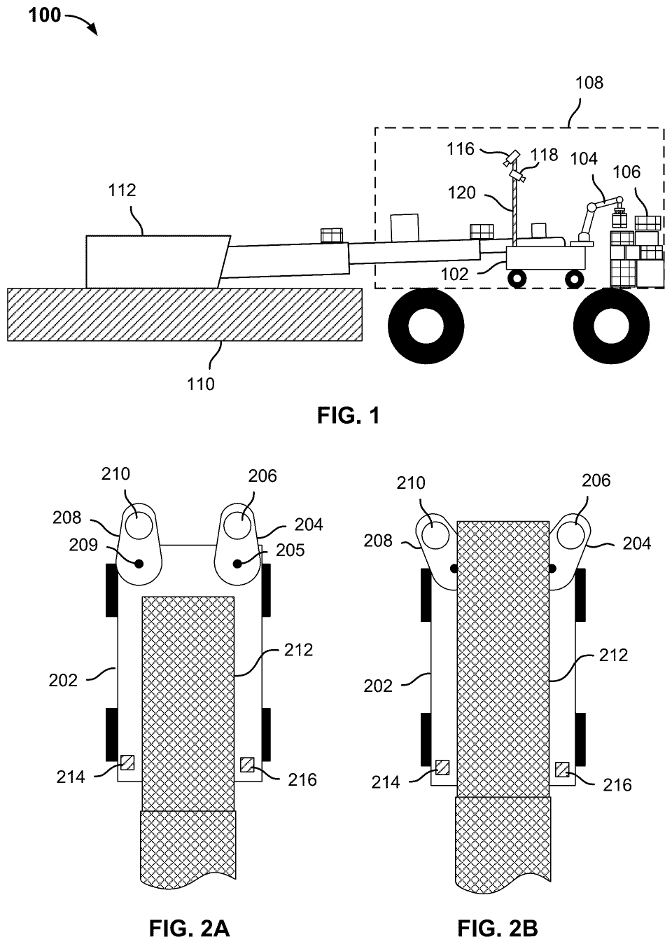

FIG. 1 is a diagram illustrating an embodiment of a robotic truck loader system. In the example shown, system and environment 100 includes a robotic truck loader comprising a robotically controlled rover (or other mobile base) 102 having one or more robotic arms 104 mounted thereon. In this example, each robotic arm 104 is equipped with a suction type end effector. The robotic truck loader/unloader is used to load or unload boxes, e.g., box 106, from/to the interior of a truck, trailer, or other container 108. As shown, truck 108 has been backed into a loading bay adjacent to loading dock 110 on which an extendable conveyor 112 is mounted (in a fixed position and orientation, in this example).

As shown in FIG. 1, the extendable conveyor 112 has been extended into truck 108 into a position that places a distal end of the extendable conveyor 112 in a position adjacent to the robotic arm 104. For example, a pick/place location at the distal end of the extendable conveyor 112 may be positioned within reach of the robotic arm 104, such that the robotic arm 104 may be used to pick boxes (or other items) from the conveyor 112 and stack them in the truck 108, in the case of loading, or remove items from the truck 108 and place them on the extendable conveyor 112, in the case of unloading.

Cameras 116 and 118 mounted on pole/frame 120 generate images used by a computer vision system to detect boxes (e.g., 106) to be picked/placed and to make a plan to use robotic arm 104 to pick/place each box. In various embodiments, images generated by cameras 116 and 118 and/or other sensor data may be used to control one or both of the truck loader 102, 104 and the extendable conveyor 112. For example, images may be used to drive the truck loader 102, 104 into the truck 108 and to subsequently move the truck loader 102, 104 further into or farther out of the truck 108, e.g., as walls of boxes are unloaded or loaded.

In some embodiments, images from cameras 116 and 118 and/or other sensor data may be used to control the extension or retraction or elevation/angle of the conveyor 112, in a manner that avoids damage to boxes and/or equipment. For example, the truck loader 102, 104 may be moved into a position in the truck 108, and the extendable conveyor 112 then controlled to move the conveyor 112 into a position adjacent to the truck loader 102, 104, e.g., as shown in FIG. 1. In some embodiments, a fiducial marker or markers may be placed on conveyor 112, to better enable the computer vision system to be used to detect and determine the position and orientation of the conveyor 112. In some embodiments, features of conveyor 112 may be recognized by the computer vision system and used to detect the position and orientation of conveyor 112. In various embodiments, sensors other than and/or in addition to cameras may be used to detect and/or control one or more of the presence, location, and orientation of the conveyor 112, such as LIDAR, sound, active or passive IR tags, etc.

In the example shown in FIG. 1, in the deployed position shown, conveyor 112 extends over the rover/mobile chassis 102 and adjacent to/through pole/frame 120 to place the distal end of conveyor 112 within reach of the robotic arm(s) 104. In some alternative embodiments, conveyor 112 is positioned near the back end of robotic truck loader 102, 104 and a transfer conveyor located near and/or integrated with the robotic truck loader 102, 104 is used to further convey items from the extendable conveyor 112 to the pick location near the robotic arm(s) 104, in the case of loading, or to carry items to the extendable conveyor 112 from the location in which the robotic arm(s) 104 placed the item(s), in the case of unloading. In some such embodiments, a robotic system as disclosed herein controls one or more of the position and orientation of the extendable conveyor 112 and the truck loader 102, 104 (and, in some cases, the transfer conveyor) to ensure items are not dropped and equipment is not damaged.

FIG. 2A is a diagram illustrating an embodiment of a robotic truck loader system. In the example and state shown, the robotic truck loader includes a robotically controlled rover or other mobile chassis 202, a first (right side, viewed from the top, as shown) robotic arm shoulder positioner 204 configured to be rotated about an axis 205 to position a robotic arm attached to shoulder mount 206 into a desired position along a circular range of motion centered on the axis of rotation 205; and a second (left side, viewed from the top, as shown) robotic arm shoulder positioner 208 configured to be rotated about an axis 209 to position a robotic arm attached to shoulder mount 210 into a desired position along a circular range of motion centered on the axis of rotation 209. In the state shown, conveyor 212 has been extended between poles 214 and 216 on either side of the rover 202 to place a pick/place site at the distal end of conveyor 212 within reach or robotic arms (not shown) mounted on shoulder mounts 206, 210.

FIG. 2B is a diagram illustrating an embodiment of a robotic truck loader system. In the example shown, the truck loader of FIG. 2A has been reconfigured by rotating the right shoulder positioner 204 clockwise and the left shoulder positioner 208 counterclockwise to create sufficient space between the shoulder mounts 206, 210 and robotic arms attached thereto (not shown) to allow the conveyor 212 to be extended further into the truck into a position between the robotic arms.

In various embodiments, a control computer comprising a robotic truck loader system is configured to determine the best location, orientation, and pose (e.g., shoulder positioner rotation) of the elements comprising the robotic truck loader and to control the extent to which the extendable conveyor is extended into the truck and/or relative to the robotic truck loader, to maximize efficiency and throughput without dropping or damaging items being loaded/unloaded and without damaging equipment.

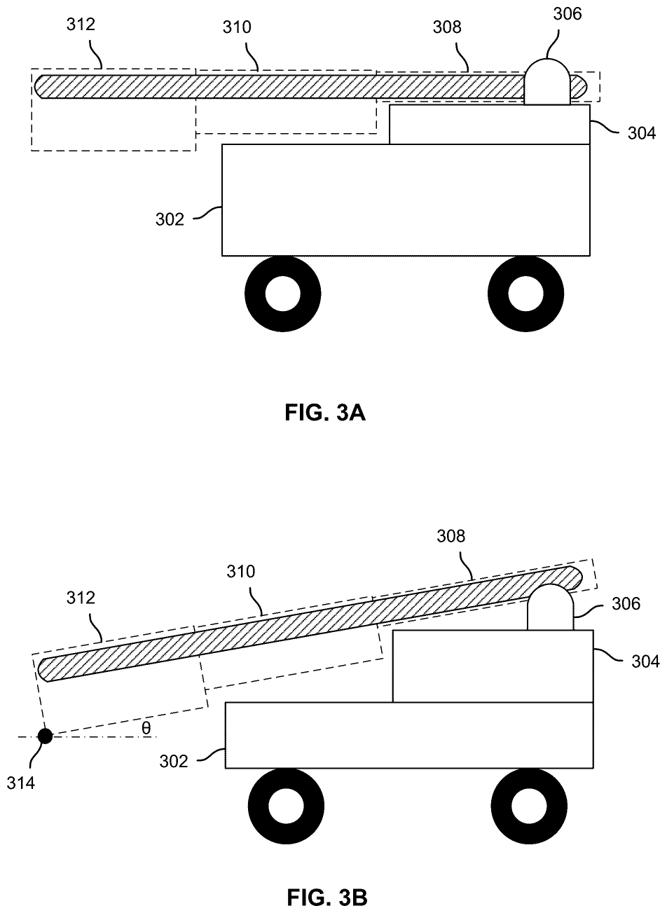

FIG. 3A is a diagram illustrating an embodiment of a robotic truck loader system. In the example shown, the robotic truck loader includes a robotically controlled rover comprising a base 302 and superstructure 304 on which a robotic arm 306 (shoulder only shown) is mounted. An extendable conveyor comprising telescoping segments 308, 310, and 312 is extended over the rover 302 and superstructure 304 in a manner that takes into account the varied vertical clearance required to accommodate the respective segments 308, 310, 312 without collision. In various embodiments, a control computer configured to control one or both of the robotic truck loader 302, 304, 306 and the extendable conveyor 308, 310, 312 in a manner that facilitates loading/unloading without dropping boxes (or other items) or damaging equipment.

FIG. 3B is a diagram illustrating an embodiment of a robotic truck loader system. In the example shown, the extendable conveyor is shown in a tilted position that elevates the distal end of the conveyor, e.g., segment 308, to enable the superstructure 304 to be cleared and the distal end, i.e., the pick/place location, to be positioned near the robotic arm 306. In various embodiments, a control computer configured to control one or both of the robotic truck loader 302, 304, 306 and the extendable conveyor 308, 310, 312 is configured to control/adjust the angular tilt of the extendable conveyor 308, 310, 312 in a manner that facilitates loading/unloading without dropping boxes (or other items) or damaging equipment.

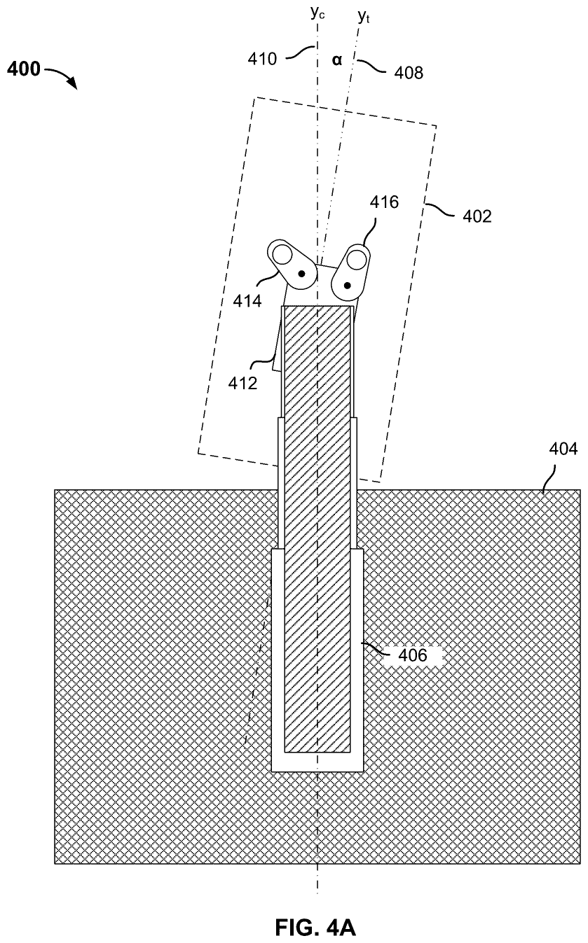

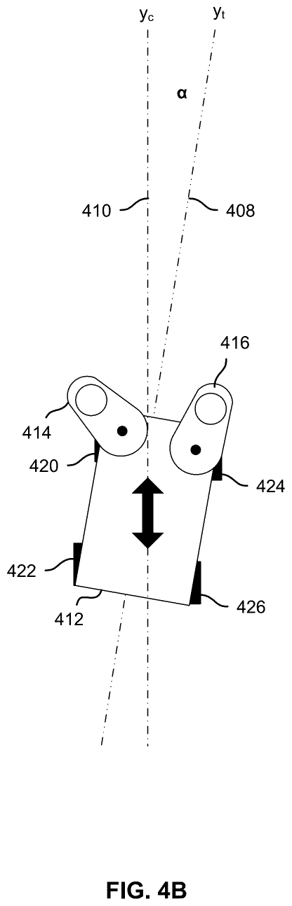

FIG. 4A is a diagram illustrating an embodiment of a robotic truck loader system. In the example shown, system and environment 400 includes a truck/trailer 402 that has been backed into a position adjacent to loading dock 404, on which an extendable conveyor 406 is mounted, in a manner resulting in a central longitudinal axis yₜ of the truck/trailer 408 being misaligned (by angle α) with the central longitudinal axis y_{c} 410 of conveyor 406. In the example shown, a robotic truck loader comprising rover 412 and robotic arms (not shown) mounted on shoulder positioners 414, 416 is positioned in truck 402. The truck loader 412, 414, 416 is positioned in alignment with the longitudinal axis 408 of the truck. In various embodiments, the misalignment is taken into account in controlling the conveyor 406 to extend as near as possible to the robotic arms mounted on shoulder positioners 414, 416 without colliding. In addition, the shoulder positioners 414, 416 have been rotated into positions to more fully admit the extendable conveyor 406 without collision and while keeping the pick/place region at the distal end of conveyor 406 and the items in truck 402 within reach of the robotic arms mounted to shoulder positioners 414, 416.

FIG. 4B is a diagram illustrating an embodiment of a robotic truck loader system. FIG. 4B shows a close-up view of the robotic truck loader 412, 414, 416. As shown in FIG. 4B, robotic truck loader 412, 414, 416 can be seen to include four fully independently controllable drive wheels 420, 422, 424, and 426, enabling the robotic truck loader 412, 414, 416 to be driven in any direction even while changing its orientation in the x-y plane. As shown, the drive system of robotic truck loader 412, 414, 416, in this example, enables the robotic truck loader 412, 414, 416 to move along the longitudinal axis 410 of the conveyor even while maintaining the longitudinal axis of the robotic truck loader 412, 414, 416 to remain aligned with the longitudinal axis 408 of the truck, or vice versa. In various embodiments, a drive system as illustrated by FIG. 4B facilitates synchronized movement of the truck loader and conveyor into/out of the trailer, even in the case of misalignment.

While in the example shown in FIGS. 4A and 4B the misalignment is an angular misalignment, in various embodiments similar techniques are used to handle a misalignment comprising a lateral offset, i.e., between the longitudinal axis of the conveyor and the point at which the longitudinal axis of the truck/trailer intersects the back (loading dock facing) door of the truck/trailer.

In some embodiments, due to misalignment or otherwise, the extendable conveyor may not be able to be extended safely fully into the truck/trailer. In some embodiments, such a condition is detected, and the extendable conveyor is controlled to be extended no further into the truck/trailer than is safe. If needed, the rover/robot shuttles items between the parts of the truck/trailer into which the extendable conveyor cannot be extended to pick items from or place items to a pick/place location on the distal end of the extendable conveyor.

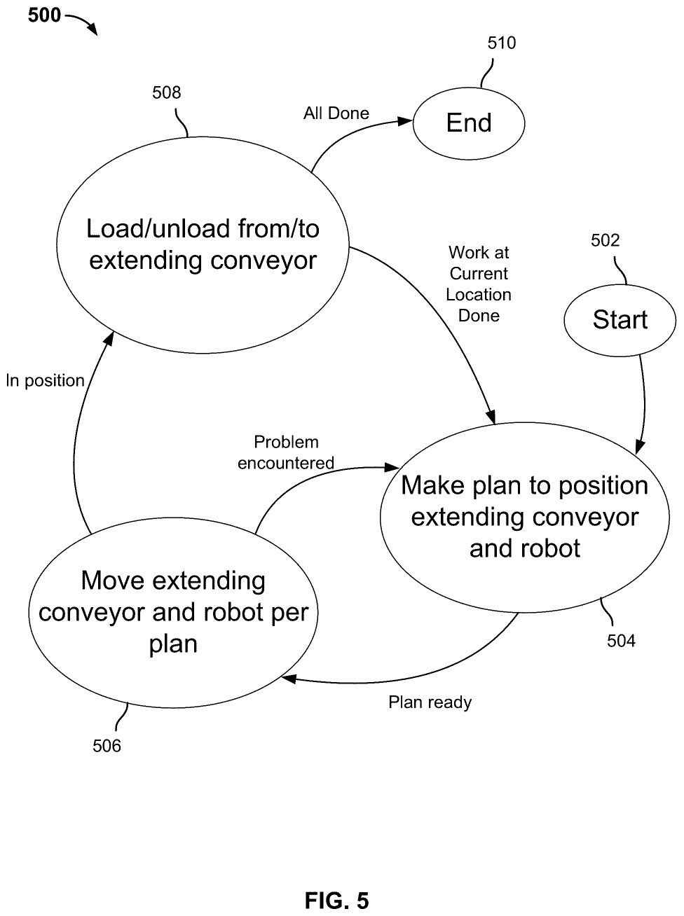

FIG. 5 is a state diagram illustrating an embodiment of a process to control a robotic truck loader system. In the example shown, the control/process illustrated by state diagram 500 starts at start state 502 and advances to state 504, in which the robotic truck loader system makes a plan to position one or both of the robotic truck loader (e.g., rover and robotic arms) and the extendable conveyor into positions, orientations, and configurations that enable items to be loaded onto or unloaded from a location in the truck/trailer. If the truck unloader and conveyor are positioned outside of the truck/trailer initially, the plan may include driving the truck unloader into the truck followed by extending the conveyor into the truck into a position such that the distal end is within reach of the robotic arms.

Once a plan has been made, processing advances to state 506 in which the robotic truck loader and/or conveyor are moved into position, according to the plan. Once in position, processing advances to state 508 in which items are loaded into or unloaded from the truck/trailer. Once items within reach of the robotic truck loader have been unloaded or locations within reach of the robotic truck loader have been filled in the case of loading, processing returns to state 504, if more work remains to be done, in which a next position and orientation/configuration of the robotic truck loader and/or extendable conveyor are determined and plans are generated to move the equipment into the determined positions, orientation, and configuration. Once all parts of the truck have been loaded or unloaded (state 508), the process enters the done state 510.

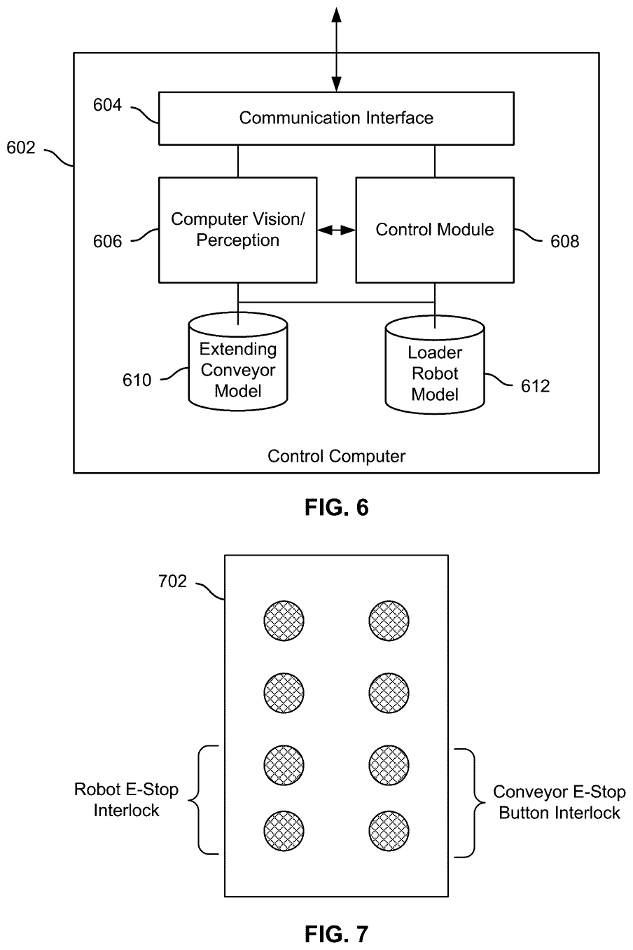

FIG. 6 is a block diagram illustrating an embodiment of a control computer to control a robotic truck loader system. In various embodiments, control computer 602 may be integrated in the robotic truck loader and/or may be in an adjacent space and in communication with the truck loader, e.g., via wireless or other communication. In the example shown, control computer 602 includes a communication interface 604 to provide connectivity to receive sensor data from and/or control the operation of cameras or other sensors and to receive position information from and send control commands to one or more of a rover and/or robotic arms comprising a robotic truck unloader, a transfer conveyor, and/or an extendable conveyor, as described herein.

The control computer 602 further includes a computer vision/perception module 606 configured to receive image and/or other sensor data, e.g., from cameras and/or other sensors mounted on the robotic truck unloader or in the truck or work area, to determine, monitor, and control the position of one or more of the robotic truck loader, the robotic arms mounted thereon, and the extendable (or transfer) conveyor. A control module 608 implements control algorithms, using the view of the work area provided by the computer vision/perception module 606. Position and other feedback from controlled elements are received via the communication interface 604 and used to maintain a current estimated state of the system, including the position, orientation, and pose of the robotic truck loader and its component elements (rover, wheels, arms, etc.). Control module 608 uses the estimate state and models of the controlled elements, e.g., conveyor model 610 and truck loader model 612, to generate a plan to move the elements into a next position and to operate the elements to load/unload (e.g., extend or retract conveyor, change conveyor tilt, start/stop conveyor, move rover to planned position and orientation, rotate shoulder mounts to determined rotation, operate robotic arms to pick/place, etc.) Commands to control controlled elements are sent via the communication interface 604.

FIG. 7 is a diagram illustrating an electrical connector used to provide a control interface between a robotic truck loader system and an extendable conveyor. In some embodiments, control of the extendable conveyor is realized by connecting a cable between the robotic truck loader and the extendable conveyor. In some embodiments, a standard 16-pin (or other) connector is used. For clarity, only eight pins are shown as being included in connector 702 of FIG. 7. In the example shown, the two pins in the bottom left are designated to be used to transmit/receive robot emergency stop (E-Stop) signals. The pins may be used, for example, to communicate to the extendable conveyor that the robotic truck loader has initiated an emergency stop. In some embodiments, the extendable conveyor would perform an emergency stop of the extendable conveyor in response. Two pins are used to carry the same signal for redundancy. Similarly, the two pins at the bottom right are designated to provide to the robotic truck loader a signal indicating that an emergency stop of the extendable conveyor has been initiated, e.g., by a human worker depressing an emergency stop button on the conveyor base housing. Again, two pins carry the same signal for redundancy. In various embodiments, the robotic truck loader initiates an emergency stop of the robotic truck loader in response to receiving the indication that an emergency stop of the extendable conveyor has been initiated.

In various embodiments, one or more of the following are done and/or provided:
Laser Scanners (or other distance sensor) are used to localize a feature that is retroreflective on the extendable conveyor. In some embodiments, the feature is designed to be a breakaway feature attached to the extendable conveyor via a magnet as a safety feature.
Use laser scanner to localize the trailer walls and quantify misalignment between the rover, the walls, and the extendable conveyor.
Use controller with feedback from laser scanner, and a state estimate of rover/extendable conveyor gap using odometry and calculated dynamics to control the gap accurately given scanner frequency is 8 Hz.
Estimate position between sensor readings.
Use scanner to identify the back of the trailer for load and the first wall of boxes for unload.
Control misalignment to account for extendable conveyor/rover misalignment tolerance and robot misalignment tolerance from trailer center to ensure maximum reachability of robots.
Provide a physical or wireless interface with the extendable conveyor to send signals to extend/retract boom, advance/reverse conveyor, as required to maintain gap.
Physical Interface to allow for transmitting safety signals to ESTOP/PSTOP the rover when the extendable conveyor is ESTOP/PSTOP and vice versa.
Provide for continuous smooth motion with gap control between extendable conveyor and rover using velocity control, state estimations and localization. In some embodiments, the control is a closed loop and can go up to 1 foot per second.

In some embodiments, the back and side walls of the truck/trailer/container are localized by using a laser scanner two-dimensional point cloud to do a parallel line fit of the side walls and calculate pose of rover with respect to the center line. In some embodiments, lines from two or more scanners (e.g., one on the front and another on the rear of the robotic truck loader) are fused to generate a view of the walls. In some embodiments, other sensors are used to detect and localize the back and side walls, such as one or more cameras, ultrasonic sensors, etc.

In some embodiments, the position and orientation of an extendable conveyor are estimated by fusing truck loader rover odometry with extendable conveyor odometry (based on estimated extendable conveyor dynamics and rover wheel encoder information, for example) and/or using Localization Information (extendable conveyor Localization+Wall Pose).

When the system is static, localization can be reliable but due to the low update frequency (8 Hz) multiple sensor estimates are fused to accurately localize extendable conveyor. In various embodiments, one or more of phase shift between scanners (feature location), wheel odometry, and extendable conveyor dynamics, are used to accurately localize the extendable conveyor.

In various embodiments, the control paradigm for the robotic truck loader is characterized by and/or exhibits one or more of the following:
Adjust heading of rover and speed to align the rover with a target pose accounting for misalignment tolerances and accounting for obstacle collision.
Adjust speed of rover to keep the relative position of rover and conveyor constant and control to be with accuracy of +−3 cm.
Estimate extendable conveyor state and adjust extendable conveyor model on the fly.
Detect slip and drift by rover.
Velocity control of wheel between application and driver.
Watchdog on driver expecting new velocity command every 30 milliseconds.

In various embodiments, a system as disclosed herein can be augmented/adapted to be used for any goods to robotic rover integration needs.

Further improvements on usability are provided in some embodiments, e.g., a wireless connection between the rover and the extendable conveyor. In some embodiments, sensors having higher refresh/data rates may be used, e.g., 3D cameras may be used to track and control the position of the extendable conveyor relative to the rover and/or transfer conveyor, as disclosed herein

Techniques disclosed herein can be used, in various embodiments, for tracking and controlling any conveying system with a robotic rover to transfer goods to be handled by robots.

Although the foregoing embodiments have been described in some detail for purposes of clarity of understanding, the invention is not limited to the details provided. There are many alternative ways of implementing the invention. The disclosed embodiments are illustrative and not restrictive.

1. A robotic system, comprising:
communication interface; and
a processor coupled to the communication interface and configured to:
receive sensor data via the communication interface;
use the sensor data to determine a position and orientation of an extendable conveyor relative to a robotic loader comprising one or more robotic arms mounted on a robotically controlled rover; and
use the determined position and orientation of the extendable conveyor relative to the robotic loader to control one or both of the extendable conveyor and the robotic loader to place the extendable conveyor and robotic loader to position a distal end of the extendable conveyor within reach of the one or more robotic arms at a location within a work area from which one or more pick or placement locations within the work area are within reach of at least one of the one or more robotic arms.

2. The system of claim 1, wherein the sensor data comprises image data generated by one or more cameras.

3. The system of claim 1, wherein the processor is configured to control an extent to which the extendable conveyor is extended.

4. The system of claim 1, wherein the processor is configured to control an angle above the horizontal to which the extendable conveyor is tilted.

5. The system of claim 1, wherein the processor is configured to control one or both of the extendable conveyor and the robotic loader at least in part by determining a plan to move one or both of the extendable conveyor and the robotic loader into a position and configuration associated with said location within the work area.

6. The system of claim 5, wherein position and configuration are determined at least in part to position a distal end of the extendable conveyor within reach of the one or more robotic arms.

7. The system of claim 1, wherein each of the robotic arms is mounted on a shoulder positioner structure that is rotatably mounted on the rover, the axis of rotation of the shoulder positioner being offset from a location at which the robotic arm is mounted on the shoulder positioner and wherein processor is further configured to rotate the shoulder positioner into a position that allows the extendable conveyor to be extended further into the work area into a position between the robotic arms.

8. The system of claim 1, wherein the work area comprises the interior of a truck or other container and the processor is configured to use the sensor data to determine an estimated location of the side walls of the truck or other container.

9. The system of claim 8, wherein the processor determines the estimated location of the side walls at least in part by computing a parallel line fit of the sensor data.

10. The system of claim 9, wherein the sensor data comprises point cloud data generated by one or more laser sensors.

11. The system of claim 1, wherein the rover has a plurality of independently controlled drive devices and the processor is configured to control the direction and rotation of each drive device independently to control the position and orientation of the rover in the work area.

12. The system of claim 1, wherein the processor is configured to control the extendable conveyor and truck loader, including by moving the extendable conveyor and truck loader within the work area to position the distal end of the extendable conveyor within reach of the one or more robotic arms while moving the extendable conveyor and truck loader within the work area.

13. The system of claim 1, wherein the work area comprises a truck or other container positioned adjacent to a loading area such that a longitudinal axis of the truck or other container is misaligned with a longitudinal axis of the extendable conveyor and the processor is further configured to take the misalignment into consideration in determining how to control one or both of the extendable conveyor and the robotic loader to position the distal end of the extendable conveyor within reach of the one or more robotic arms within the truck or other container.

14. The system of claim 13, wherein the processor is further configured to take the misalignment into consideration in determining how to control one or both of the extendable conveyor and the robotic loader to move one or both of the extendable conveyor and the robotic loader within the truck or other container.

15. The system of claim 13, wherein the misalignment comprises one or both of an angular misalignment and a lateral offset.

16. The system of claim 1, wherein the processor is further configured to detect that the extendable conveyor cannot safely be extended fully into the workspace and, in response, control the robotic loader to shuttle one or more items between the extendable conveyor and a location in the workspace to which the extendable conveyor cannot safely be extended.

17. The system of claim 1, wherein the work area comprises a truck or other container and in the case of a loading operation the processor is configured to cause the extendable conveyor and robotic loader to back out of the truck together as the truck or other container is filled with items.

18. The system of claim 1, wherein the work area comprises a truck or other container and in the case of an unloading operation the processor is configured to cause the extendable conveyor and robotic loader to move further into the truck as the truck or other container is unloaded.

19. The system of claim 1, wherein the extendable conveyor is coupled to processor via a physical cable that includes a structure to carry to the extendable conveyor a signal indicating that an emergency stop has been initiated with respect to the robotic loader and wherein the extendable conveyor is configured to respond to said signal by initiating an emergency stop of the extendable conveyor.

20. The system of claim 19, wherein the physical cable further includes a structure to carry to the robotic loader a signal indicating that an emergency stop has been initiated with respect to the extendable conveyor and wherein the robotic loader is configured to respond to said signal by initiating an emergency stop of the robotic loader.

21. A method of controlling a robotic loader system, comprising:
receiving sensor data via a communication interface;
using the sensor data to determine a position and orientation of an extendable conveyor relative to a robotic loader comprising one or more robotic arms mounted on a robotically controlled rover; and
using the determined position and orientation of the extendable conveyor relative to the robotic loader to control one or both of the extendable conveyor and the robotic loader to place the extendable conveyor and robotic loader to position a distal end of the extendable conveyor within reach of the one or more robotic arms at a location within a work area from which one or more pick or placement locations within the work area are within reach of at least one of the one or more robotic arms.

22. A computer program product embodied in a non-transitory computer readable medium and comprising computer instructions for:
receiving sensor data via a communication interface;
using the sensor data to determine a position and orientation of an extendable conveyor relative to a robotic loader comprising one or more robotic arms mounted on a robotically controlled rover; and
using the determined position and orientation of the extendable conveyor relative to the robotic loader to control one or both of the extendable conveyor and the robotic loader to place the extendable conveyor and robotic loader to position a distal end of the extendable conveyor within reach of the one or more robotic arms at a location within a work area from which one or more pick or placement locations within the work area are within reach of at least one of the one or more robotic arms.
